(19) United States
(12) Patent Application Publication
(10) Pub. No.: US 2003/0107690 A1
(43) Pub. Date: Jun. 12, 2003

(54) System and method for ozone cleaning a liquid crystal display structure

(76) Inventor: Hirohiko Nishiki, Tenri-shi (JP)

Correspondence Address: David C. Ripma, Patent Counsel, Sharp Laboratories of America, Inc., 5750 NW Pacific Rim Boulevard, Camas, WA, 98607, US

(21) Appl. No.: 10/021,342

(22) Filed: Dec. 12, 2001

(51) Int. Cl. G02F 1/1335

(52) U.S. Cl. 349/113

(57) ABSTRACT

A method has been provided for forming a liquid crystal display (LCD) structure, such as a reflector, that is resistant to ozone cleaning processes. A conventional LCD reflector includes an indium tin oxide (ITO) electrode and overlying Al reflector, separated by a Mo barrier. Since Mo is more susceptible to ozone etching than Al, the reflector can be damaged by ozone photoresist stripping processes. The present invention replaces the Mo barrier layer with a material such as Ta, which is less susceptible to ozone.

### BACKGROUND OF THE INVENTION

1. Field of the Invention

This invention generally relates to integrated circuit (IC) and liquid crystal display (LCD) fabrication processes and, more particularly, to a system and method for the use of ozone in the cleaning of IC and LCD surfaces.

2. Description of the Related Art

An LCD panel is indispensable component for notebook type personal computers (PCs), because of its light weight and thin profile, compared to a cathode ray tube (CRT) type monitor. In particular, reflective type LCD monitors are commonly used, not only for notebook PCs, but also for personal digital assistants (PDAs), video cameras, portable video game, and other devices using displays.

A reflective type LCD is much lighter and thinner than a transmissive type LCD. Hence, the market for reflective LCDs will only increase. However, reflective type LCDs are much more expensive than CRTs or transmissive LCDs, and cost reduction is serious design issue. One method of reducing the cost of reflective type LCDs would be to simplify fabrication processes.

As noted in U.S. Pat. No. 5,464,480 (Matthews), in the fabrication of semiconductor wafers, several process steps require contacting the wafers with fluids. Examples of such process steps include etching, photoresist stripping, and prediffusion cleaning. Often the chemicals utilized in these steps are quite hazardous in that they may comprise strong acids, alkalis, or volatile solvents. The equipment conventionally used for contacting semiconductor wafers with process fluid consists of a series of tanks or sinks into which cassette loads of semiconductor wafers are dipped. Such conventional wet processing equipment poses several difficulties.

First, moving the wafers from tank to tank may result in contamination, which contamination is extremely detrimental to the microscopic circuits which the fabrication process creates. Second, the hazardous chemicals and deionized water which are used have to be regularly replaced with new solutions, usually introduced to the tank by bottle pour, chemical distribution or from building facilities in the case of deionized water. The chemicals generally are manufactured by chemical companies and shipped to the semiconductor manufacturing plant. The chemical purity is thus limited by the quality of the water used by the chemical manufacturers, and by the container used for shipping and storing the chemical and by the handling of the chemical.

Moreover, as chemicals age, they can become contaminated with impurities from the air and from the wafers. The treatment of the last batch of wafers prior to fluid rejuvenation may not be as effective as treatment of the first batch of wafers in a new solution. Non-uniform treatment is a major concern in semiconductor manufacturing.

Some of the fluid contact steps of semiconductor manufacture include removal of organic materials and impurities from the wafer surface. For example, in the manufacture of integrated circuits, it is customary to bake a photoresist coating onto a silicon wafer as part of the manufacturing process. This coating of photoresist or organic material must be removed after processing. Sometimes, a wet photoresist strip process is performed by a solution of sulfuric acid spiked with an oxidizer of either hydrogen peroxide or ozone. However, there are many disadvantages to using a solution of sulfuric acid and an oxidizer to strip photoresist from wafers during semiconductor manufacture. First, the by-product of the resist strip reaction when hydrogen peroxide is used as the oxidizer is water, which dilutes the concentration of the bath and thereby reduces its ability to strip photoresist. Second, this process operates at a high temperature, generally between 80 degrees and 150 degrees C., typically above about 130 degrees C., which mandates the use of special heat resistant materials and components in order to house, circulate and filter the solution, as well as requires extra energy to conduct the cleaning process. Third, the solution is hazardous to handle and dispose of and expensive to manufacture, transport and store.

Moreover, due to the build-up of impurities both dissolved and undissolved in the process bath, the solution must be changed periodically. Typically, the interval for chemical change out is about every eight hours. Because the chemical adversely affects the drain plumbing, the solution must be cooled to less than about 90 degrees C. prior to disposal. Thus, use of this photoresist stripping process requires either the use of additional tanks to contain the hot solution or the shut down of the process station during the chemical change period, reducing wafer throughput and increasing cost of ownership. Finally, after use of a sulfuric acid solution for removal of photoresist, the wafers must be rinsed in hot deionized water since sulfate residues may crystallize on the wafer during processing causing process defects.

Another process often utilized for the removal of organic and metallic surface contaminants is the “RCA clean” process, which uses a first solution of ammonium hydroxide, hydrogen peroxide, and water and a second solution of hydrochloric acid, hydrogen peroxide, and water. The RCA cleaning solutions typically are mixed in separate tanks. The wafers are first subjected to cleaning by the ammonium hydroxide solution, then are moved to a rinse tank, then to a tank containing the hydrochloric acid cleaning solution, and then to a final rinse tank. This process, like the sulfuric acid process, has the disadvantage of using strong chemicals. Moreover, the wafers are exposed to air during the transfers from tank to tank, allowing for contamination. Finally, the use of peroxide may cause the wafers to suffer aluminum contamination from the deposition of aluminum in the high pH ammonium hydroxide solution which is not totally removed in the hydrochloric solution.

U.S. Pat. No. 5,082,518 (Molinaro) describes a different approach to improving the sulfuric acid and oxidizer process of cleaning semiconductor wafers. The system in this patent provides a gas distribution system which includes a sparger plate with diffusion holes for distributing gas throughout the bath in the tank. Thus, rather than using a separate tank for mixing, this invention provides an apparatus which distributes ozone directly into the treatment tank containing sulfuric acid. It has been found, however, that this diffusion system suffers several disadvantages. First, the efficiency of ozone distribution and absorption into the water is lessened by the large bubbles of ozone produced by the apparatus. The amount of ozone absorbed is important to its ability to react with the sulfuric acid to remove organic materials from the wafers. Moreover, it is believed that ozone diffusion remains a problem. Finally, as with previous attempts to improve cleaning processes for wafers, hazardous chemicals are required, creating handling and disposal problems.

A process for the removal of organic materials during semiconductor manufacture that can avoid the above-mentioned problems, while providing effective removal of organic materials, would be of great value to the semiconductor industry. New stripping and cleaning processes, using ozone, have been identified as a suitable technology to reduce costs in the processing of thin film transistor (TFT) active display LCDs. The new stripping methods use either ozone gas or ozonated water to reduce or eliminate organic stripper, making the ozone stripping and cleaning process a cost effective and environmentally friendly. Organic strippers require special treatments and are, therefore, expensive. However, there are some process issues that must be solved before ozone stripping becomes practical in a manufacturing environment. One issue concerns the damage that can occur to a reflective electrode (reflector) in a reflective LCD during ozone stripping.

Aluminum (Al) and molybdenum (Mo) are commonly used elements in a reflector structure. Al has a high reflectivity, but if it is directly deposited on indium tin oxide (ITO), a commonly used material for drain electrodes, the ITO layer can become damaged by Al corrosion. Therefore, Mo is used as a barrier, and Al/Mo/ITO structures are common in LCD fabrication. However, both Al and Mo are etched by ozone during the ozone stripping and cleaning process. Hence, the ozone stripping process is damaging to conventional reflector LCDs.

FIGS. 1a and 1b illustrate a conventional problem in using ozone as a cleaner in TFT-LCD manufacturing (prior art). FIG. 1a depicts an Al/Mo/ITO structure, where photoresist has been patterned to cover the Al. One of the difficulties is in the damage to the reflective electrodes of reflective type LCD. Both Al and Mo are etchable by ozone. For example, the etch rates of Al and Mo by ozone water at 85 parts per million (PPM) are 20 Å/min and 70 Å/min, respectively (pH 3.3). Typically, the strip time of the ozone water stripping process is about 45-minutes. Since it takes approximately 15-minutes to remove the photoresist overlying the Al/Mo structure, the Al is directly exposed to ozone for 30-minutes. Based on the above-mentioned assumptions, approximately 800 Å of Al is removed in this 30-minute period.

In the case of Al, the etching generally proceeds from the top of the film down. If the original Al thickness is 2000 Å, approximately 1200 Å of Al film will remain after the ozone stripping process. However, in the case of Mo, the etching mainly proceeds from the slope region, as shown in FIG. 1b. The underlayer Mo can be damaged by ozone within 10 to 30-minutes. Because of the damage to the Mo, the Al/Mo electrodes can be peeled off before the photoresist and Al are completely removed.

It would be advantageous if ozone cleaning processes could be improved to reduce the cost of LCD manufacturing.

It would be advantageous if an alternate material could be found as a barrier material, between Al and ITO layers, that was less susceptible to damage by ozone cleaning. It would be advantageous if the alternate barrier material could was a material that was resistive to ozone etching.

### SUMMARY OF THE INVENTION

Accordingly, a method has been provided for forming a structure resistant to ozone stripping in the fabrication of IC and LCD structures. The method comprises: forming a first electrically conducting layer of indium tin oxide (ITO); forming an ozone resistant barrier overlying the first electrically conducting layer from a material selected from the group including Ta (tantalum), Ti (titanium), TaN (tantalum nitride), and TiN (titanium nitride); and, forming a metal layer overlying the ozone resistive barrier from a reflective metal, such as Al.

When an LCD reflective structure is formed, forming a first electrically conducting layer includes forming an electrode; and, forming a metal layer overlying the ozone resistant barrier includes forming an LCD reflector. Alternately, when a busline IC or LCD structure is formed, then forming a metal layer overlying the ozone resistant barrier includes forming the top metal layer of a busline.

In some aspects of the invention, the method further comprises: forming a photoresist pattern with openings exposing overlying areas of the metal layer, through the openings in the photoresist; etching the exposed metal layer and underlying ozone resistant barrier; and, stripping the photoresist with an ozone compound.

When a LCD IC is being stripped, the metal layer overlying the ozone resistant barrier is Al layer, and the method further comprises: following the ozone stripping, leaving an LCD reflector structure.

Additional details and variations of the present invention ozone stripping and cleaning process are presented below, along with LCD reflector structures resistant to ozone stripping.

### BRIEF DESCRIPTION OF THE DRAWING

FIGS. 1a and 1b illustrate a conventional problem in using ozone as a cleaner in TFT-LCD manufacturing (prior art).

FIG. 2 is a graph illustrating the etch rates of a variety of materials in an ozone water environment.

FIG. 3a is a partial cross-sectional view illustrating the ozone stripping resistant LCD reflector structure of the present invention.

FIG. 3b is a partial cross-sectional view illustrating an alternate ozone stripping resistant LCD reflector structure of the present invention.

FIG. 4 is a flowchart illustrating the present invention method for forming a structure resistant to ozone stripping in the fabrication of IC or LCD structures.

FIG. 5 is a flowchart illustrating the method for forming an ozone resistance LCD IC structure.

FIG. 6 is a flowchart illustrating the method for forming a busline IC structure.

FIG. 7 is a flowchart illustrating the present invention method for stripping an IC or LCD surface.

FIG. 8 is a flowchart illustrating a method for forming a structure resistant to ozone stripping, without an ozone resistant barrier.

### DETAILED DESCRIPTION OF THE PREFERRED EMBODIMENTS

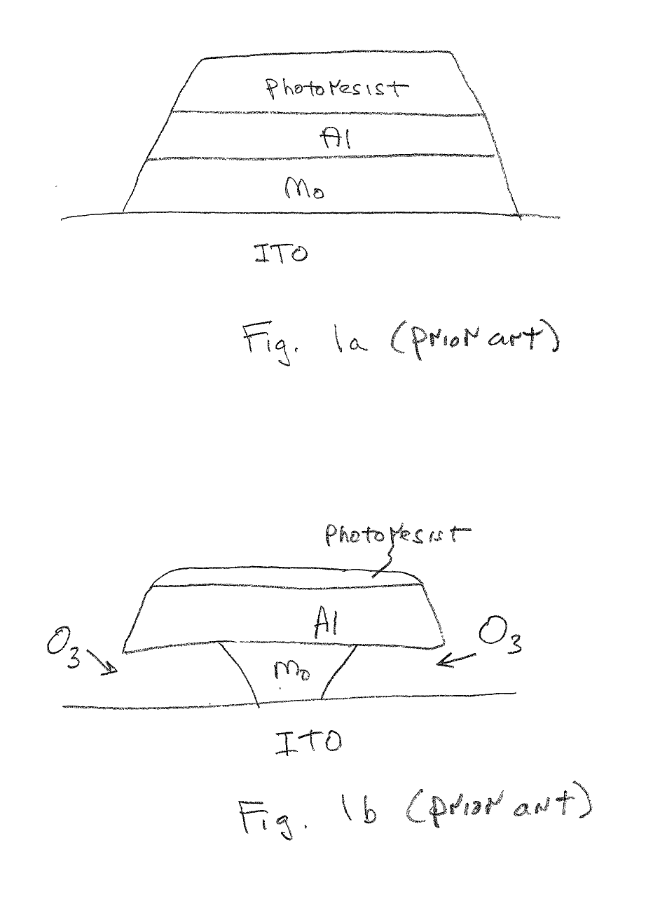

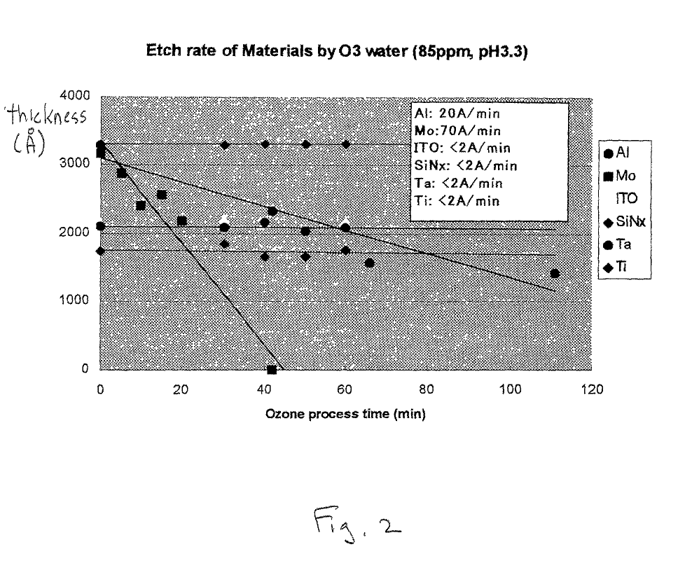

FIG. 2 is a graph illustrating the etch rates of a variety of materials in an ozone water environment. The graph shows that Mo is less susceptible to etching than either Ta or Ti. This result suggests that either of these materials may be more suitable as an Al underlayer in the formation of an LCD reflector. Alternately, the problem depicted in FIG. 1b could be addressed if either Ta, Ti, or Al could be used for the drain electrode, instead of ITO, eliminating the need for a Mo, or any other kind of barrier layer.

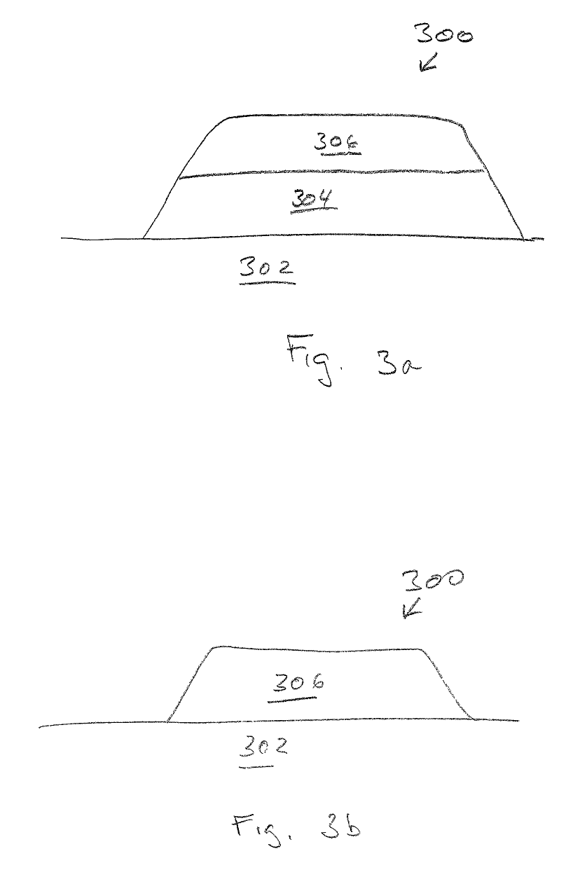

FIG. 3a is a partial cross-sectional view illustrating the ozone stripping resistant LCD reflector structure of the present invention. The LCD structure 300 comprises a first electrically conducting layer 302 and an ozone resistive barrier 304 overlying the first electrically conducting layer 302. A metal layer 306 overlies the ozone resistive barrier 304. Typically, the first electrical conducting layer 302 is selected from the group of materials including indium tin oxide (ITO). The ozone resistant barrier 304 is a material selected from the group including Ti, Ta, TiN, TaN, Al, Al compounds, tungsten (W), chrome (Cr), and copper (Cu). The metal layer 306 is a material such as Al. Other highly reflective metals could be used to form metal layer 306 instead of Al.

FIG. 3b is a partial cross-sectional view illustrating an alternate ozone stripping resistant LCD reflector structure of the present invention. The LCD structure 300 comprises a first electrically conducting layer 302. A metal layer 306 overlies the electrically conducting layer 302, as an ozone resistive barrier 304 (see FIG. 3a) is not required. Typically, the first electrical conducting layer 302 is selected from the group of materials including Ti, Ta, and Al. The metal layer 306 is a material such as Al. Other highly reflective metals could be used to form metal layer 306 instead of Al.

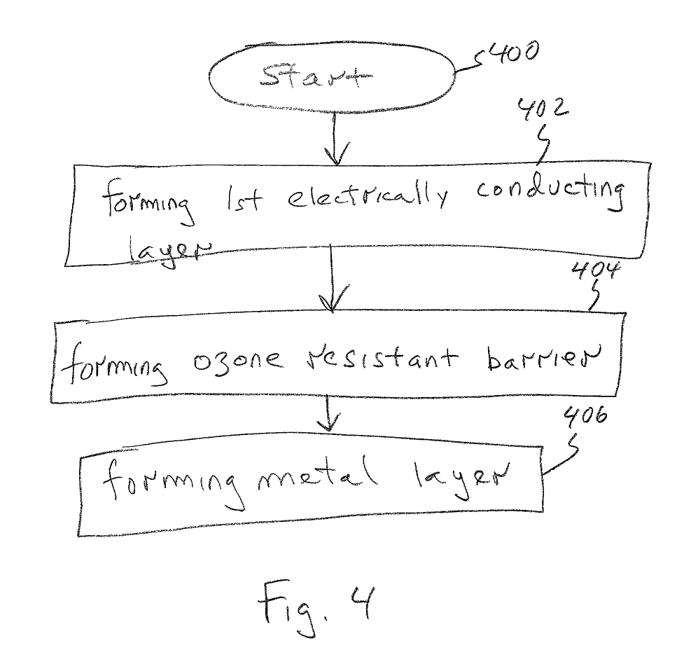

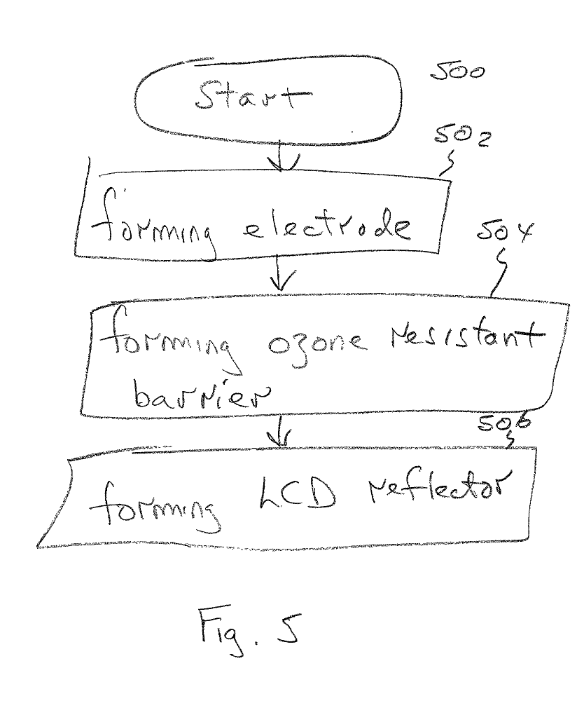

FIG. 4 is a flowchart illustrating the present invention method for forming a structure resistant to ozone stripping in the fabrication of IC or LCD structures. As used herein, LCD structures are to be considered to be a particular type of IC structure. Although this method, and the methods of FIGS. 5 through 8 below, is depicted as a sequence of numbered steps for clarity, no order should be inferred from the numbering unless explicitly stated. The method begins at Step 400. Step 402 forms a first electrically conducting layer, typically from ITO. Step 404 forms an ozone resistant barrier overlying the first electrically conducting layer. The ozone resistant barrier is a material such as Ta, Ti, TaN, TiN, Al, Al compounds, tungsten, chrome, or copper. Step 406 forms a metal layer overlying the ozone resistive barrier. The metal layer is formed from a material such as Al, or some other highly reflective metal. In some aspects of the invention forming a metal layer overlying the ozone resistant barrier in Step 406 includes forming a layer of Al having a thickness of greater than 1000 Å, for example 2000 Å.

FIG. 5 is a flowchart illustrating the method for forming an ozone resistance LCD IC structure. The method begins at Step 500. Step 502 forms an electrode, typically from ITO. Step 504 forms an ozone resistant barrier overlying the electrode from Ta, Ti, TaN, TiN, Al, Al compounds, tungsten, chrome, or copper. Step 506 forms an LCD reflector overlying the ozone resistive barrier from a reflective metal material such as Al.

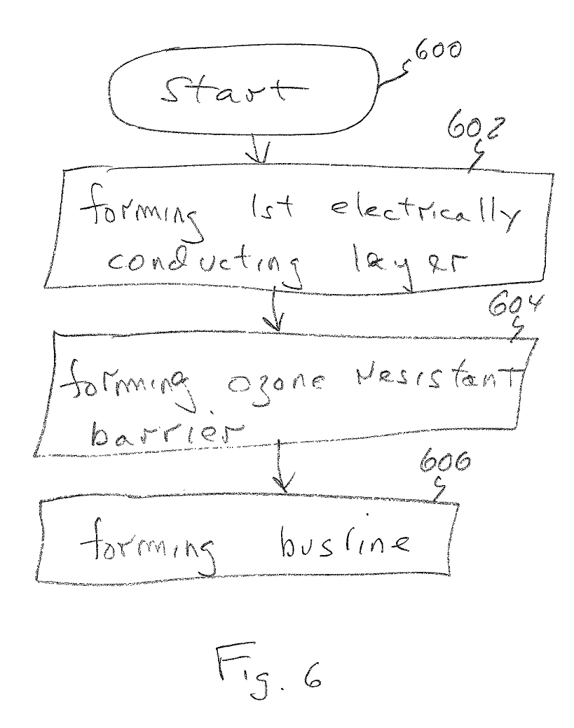

FIG. 6 is a flowchart illustrating the method for forming a busline IC structure. The method begins at Step 600. Step 602 forms a first electrically conducting layer, typically from ITO. Step 604 forms an ozone resistant barrier overlying the first electrically conducting layer from Ta, Ti, TaN, TiN, Al, Al compounds, tungsten, chrome, or copper. Step 606 forms a top metal layer of busline overlying the ozone resistive barrier from a reflective metal material such as Al.

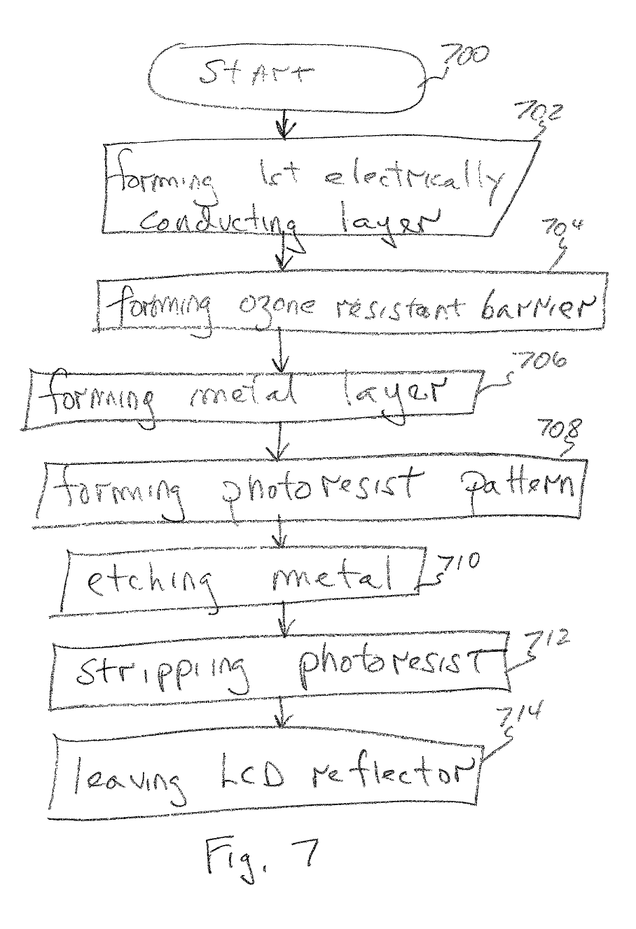

FIG. 7 is a flowchart illustrating the present invention method for stripping an IC or LCD surface. The method starts at Step 700. Step 702 forms a first electrically conducting layer. Step 704 forms an ozone resistive barrier overlying the first electrically conducting layer. Step 706 forms a metal layer overlying the ozone resistive barrier. Step 708 forms a photoresist pattern with openings exposing overlying areas of the metal layer. Step 710, through the openings in the photoresist, etches the exposed metal layer and underlying ozone resistant barrier. Step 712 strips the photoresist with an ozone compound.

As above, Step 702 includes forming a conducting layer from a material selected from the group including ITO, and Step 704 forms an ozone resistant barrier from a material selected from the group including Ta, Ti, TaN, TiN, Al, Al compounds, tungsten, chrome, and copper. Likewise, Step 706 includes forming a reflective metal layer from a reflective metal material such as Al. Forming a metal layer overlying the ozone resistant barrier in Step 706 includes forming a layer of Al having a thickness of greater than 1000 Å.

When a reflective LCD IC structure is being stripped, Step 702 forms an ITO transistor or capacitor electrode. Then, Step 714, following the ozone stripping in Step 712, leaves an LCD reflector structure.

Stripping the photoresist with an ozone compound in Step 712 includes stripping with a compound having 85 parts per million (PPM) of ozone, or greater. Further, stripping the photoresist with an ozone compound includes exposing the IC to the ozone compound for approximately 45 minutes. When Step 706 forms an Al layer having a thickness of greater than 1000 Å, then stripping the photoresist with an ozone compound in Step 712 includes removing approximately 800 Å of Al exposed by the openings in the photoresist.

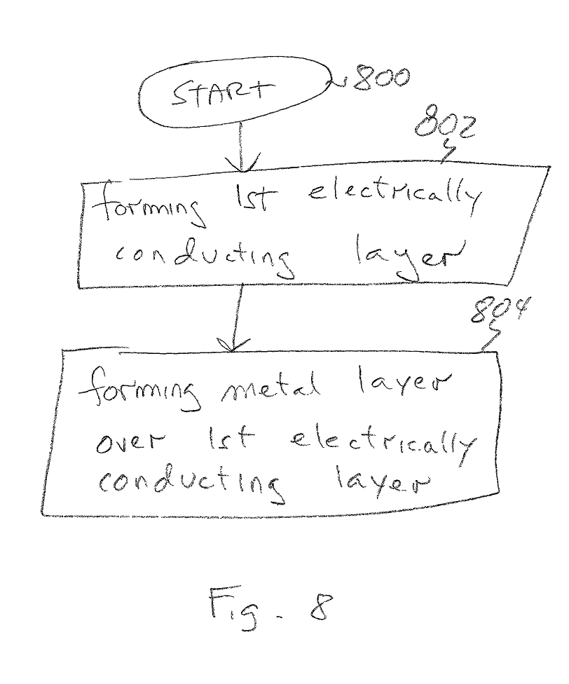

FIG. 8 is a flowchart illustrating a method for forming a structure resistant to ozone stripping, without an ozone resistant barrier. The method begins at Step 800. Step 802 forms a first electrically conducting layer from a material selected from the group including Ti, Ta, and Al. Step 804 forms a metal layer overlying the electrically conducting layer. Step 804 includes forming a reflective metal layer from a material selected from the group including Al, typically having a thickness of greater than 1000 Å.

When the method creates a reflective LCD IC structure, Step 802 includes forming an electrode and Step 804 forms an LCD reflector. When the method creates a busline IC structure, Step 804 forms the top metal layer of a busline.

A method has been providing for the fabrication an LCD structure that is resistant to ozone cleaning and stripping. A few examples of processes and structures have given, however, other variations and embodiments of the invention will occur to those skilled in the art.

We claim:

1. In the fabrication of integrated circuit (IC) structures, a method for forming a structure resistant to ozone stripping, the method comprising:
forming a first electrically conducting layer;
forming an ozone resistant barrier overlying the first electrically conducting layer; and,
forming a metal layer overlying the ozone resistive barrier.

2. The method of claim 1 wherein forming a first electrically conducting layer includes forming a conducting layer from indium tin oxide (ITO).

3. The method of claim 1 wherein forming an ozone resistant barrier overlying the first electrically conducting layer includes forming an ozone resistant barrier from a material selected from the group including Ta, Ti, TaN, TiN, Al, Al compounds, tungsten, chrome, and copper.

4. The method of claim 1 wherein forming a metal layer overlying the ozone resistant barrier includes forming a reflective metal layer from Al.

5. The method of claim 4 wherein forming a metal layer overlying the ozone resistant barrier includes forming a layer of Al having a thickness of greater than 1000 Å.

6. The method of claim 1 in which a reflective liquid crystal display (LCD) IC structure is formed;
wherein forming a first electrically conducting layer includes forming an electrode; and,
wherein forming a metal layer overlying the ozone resistant barrier includes forming an LCD reflector.

7. The method of claim 1 in which a busline IC structure is formed; and,
wherein forming a metal layer overlying the ozone resistant barrier includes forming the top metal layer of a busline.

8. In the fabrication of liquid crystal displays (LCDs) integrated circuits (ICs), a method for forming a LCD structure resistant to ozone stripping, the method comprising:
forming an indium tin oxide (ITO) layer electrode;
forming an ozone resistant barrier overlying the electrode from a material selected from the group including Ti, Ta, TiN, and TaN; and,
forming an Al reflector overlying the ozone resistant barrier.

9. A method for stripping a liquid crystal display (LCD) surface, the method comprising:
forming a first electrically conducting layer;
forming an ozone resistive barrier overlying the first electrically conducting layer;
forming a metal layer overlying the ozone resistive barrier;
forming a photoresist pattern with openings exposing overlying areas of the metal layer;
through the openings in the photoresist, etching the exposed metal layer and underlying ozone resistant barrier; and,
stripping the photoresist with an ozone compound.

10. The method of claim 9 wherein forming a first electrically conducting layer includes forming a conducting layer from indium tin oxide (ITO).

11. The method of claim 9 wherein forming an ozone resistant barrier overlying the first electrically conducting layer includes forming an ozone resistant barrier from a material selected from the group including Ta, Ti, TaN, TiN, Al, Al compounds, tungsten, chrome, and copper.

12. The method of claim 9 wherein forming a metal layer overlying the ozone resistant barrier includes forming a reflective metal layer from Al.

13. The method of claim 12 wherein forming a metal layer overlying the ozone resistant barrier includes forming a layer of Al having a thickness of greater than 1000 Å.

14. The method of claim 13 in which a reflective LCD structure is being stripped;
wherein forming a first electrically conducting layer includes forming an ITO electrode;
wherein forming an ozone resistant barrier overlying the first electrically conducting layer includes forming an ozone resistant barrier from a material selected from the group including Ta, Ti, TaN, and TiN;
wherein forming a metal layer overlying the ozone resistant barrier includes forming an Al layer; and,
the method further comprising:
following the ozone stripping, leaving an LCD reflector structure.

15. The method of claim 14 wherein stripping the photoresist with an ozone compound includes stripping with a compound having 85 parts per million (PPM) of ozone, or greater.

16. The method of claim 14 wherein stripping the photoresist with an ozone compound includes exposing the IC to the ozone compound for approximately 45 minutes.

17. The method of claim 14 wherein forming a metal layer overlying the ozone resistant barrier includes forming an Al layer having a thickness of greater than 1000 Å; and,
wherein stripping the photoresist with an ozone compound includes removing approximately 800 Å of Al exposed by the openings in the photoresist.

18. A liquid crystal display (LCD) reflector structure resistant to ozone stripping, the reflector structure comprising:
a first electrically conducting layer;
an ozone resistive barrier overlying the first electrically conducting layer; and,
a metal layer overlying the ozone resistive barrier.

19. The reflector structure of claim 18 wherein the first electrical conducting layer is indium tin oxide (ITO).

20. The reflector structure of claim 18 wherein the ozone resistant barrier is a material selected from the group including Ti, Ta, TiN, TaN, Al, Al compounds, tungsten, chrome, and copper.

21. The reflector structure of claim 18 wherein the metal layer is a reflective metal layer material selected from the group including Al.

22. A liquid crystal display (LCD) reflector structure resistant to ozone stripping, the reflector structure comprising:
a first electrically conducting layer of indium tin oxide (ITO);
an ozone resistive barrier overlying the first electrically conducting layer selected from the group including Ti, Ta, TiN, TaN, Al, Al compounds, tungsten, chrome, and copper; and,
an Al reflective metal layer overlying the ozone resistive barrier.

23. A liquid crystal display (LCD) reflector structure resistant to ozone stripping, the reflector structure comprising:
a first electrically conducting layer selected from the group including Ti, Ta, and Al; and,
a reflective metal layer overlying the first electrically conducting layer selected from the group including Al.

24. In the fabrication of integrated circuit (IC) structures, a method for forming a structure resistant to ozone stripping, the method comprising:
forming a first electrically conducting layer; and,
forming a metal layer overlying the electrically conducting layer.

25. The method of claim 24 wherein forming a first electrically conducting layer includes forming a conducting layer from a material selected from the group including Ti, Ta, and Al.

26. The method of claim 24 wherein forming a metal layer overlying the first electrically conducting layer includes forming a reflective metal layer from Al.

27. The method of claim 26 wherein forming a metal layer overlying the first electrically conducting layer includes forming a layer of Al having a thickness of greater than 1000 Å.

28. The method of claim 24 in which a reflective liquid crystal display (LCD) IC structure is formed;
wherein forming a first electrically conducting layer includes forming an electrode; and,
wherein forming a metal layer overlying the first electrically conducting layer includes forming an LCD reflector.

29. The method of claim 24 in which a busline IC structure is formed; and,
wherein forming a metal layer overlying the first electrically conducting layer includes forming the top metal layer of a busline.
